(19) United States
(12) Patent Application Publication
(10) Pub. No.: US 2026/0269689 A1
(43) Pub. Date: Sep. 10, 2026

(54) METHOD FOR COOLING AN ELECTRIC MACHINE AND AN ELECTRIC MACHINE

(71) Applicant: Dr. Ing. h.c. F. Porsche Aktiengesellschaft, Stuttgart (DE)

(72) Inventors: Raphael OESTREICHER, Waiblingen (DE); Wolfgang Maximilian BLASCHKE, Weissach-Flacht (DE)

(21) Appl. No.: 19/553,465

(22) Filed: Mar. 2, 2026

(30) Foreign Application Priority Data
Mar. 5, 2025 (DE) 10 2025 108 318.5

(51) Int. Cl. H02K 9/20; H02K 1/20; H02K 11/25

(52) U.S. Cl. CPC H02K 9/20; H02K 1/20; H02K 11/25

(57) ABSTRACT

A method cools an electric machine. The electric machine includes a cooling unit, a stator arranged in a housing, a rotor, and at least one cooling channel arranged on the stator. The method includes feeding a compressed cooling fluid through the at least one cooling channel, and releasing and decompressing the cooling fluid in a direction of the rotor via at least one nozzle formed on the at least one cooling channel, such that the cooling fluid undergoes a phase change from liquid to gaseous during expansion and an enthalpy of vaporization released during the phase change cools the rotor.

### CROSS REFERENCE TO RELATED APPLICATIONS

This application claims benefit to German Patent Application No. DE 10 2025 108 318.5, filed on March 5, 2025, which is hereby incorporated by reference herein.

### FIELD

The invention relates to a method for cooling an electric machine as well as an electric machine.

### BACKGROUND

Electric machines are central components in a variety of technical applications including electric mobility, industrial engines and renewable energy. As power requirements increase and designs become more compact, the challenge of efficiently dissipating the heat produced in the machine is growing to avoid thermal overload and ensure a high power density while maintaining a long service life. Insufficient cooling can lead to overheating of critical components, particularly the coils in the stator, as well as the permanent magnets or rotor windings in the rotor, which affects the efficiency and life of the machine.

Particularly challenging is the cooling of the rotor, as it is mounted rotationally and no direct coolant lines can be guided through it. While various direct cooling methods exist for the cooling of the stator, for example the flow of oil through the winding grooves, the thermal load on the rotor remains an unsolved problem. Permanent magnets in rotating machines, in particular neodymium iron boron magnets (NdFeB), reduce a portion of their magnetic retentive flux density and coercive field strength as the temperature increases, which negatively impacts the performance of the machine. Effective rotor cooling can thus significantly improve the efficiency and durability of the machine.

Known cooling concepts for electric machines are often based on closed fluid cooling systems or dual phase cooling systems that cool either the stator or the entire machine room. DE 10 2016 214 405 A1 discloses an electric machine with a passive dual phase cooling system that operates according to the thermosiphon principle. While this concept allows for continuous heat dissipation, it is designed for permanent temperature regulation and cannot specifically respond to sudden thermal load spikes in the rotor. In addition, the system requires precise sealing of the cooling circuit and integration of a liner between rotor and stator, making manufacturing and maintenance of the machine more complex and costly.

### SUMMARY

In an embodiment, the present disclosure provides a method for cooling an electric machine. The electric machine includes a cooling unit, a stator arranged in a housing, a rotor, and at least one cooling channel arranged on the stator. The method includes feeding a compressed cooling fluid through the at least one cooling channel; and releasing and decompressing the cooling fluid in a direction of the rotor via at least one nozzle formed on the at least one cooling channel, such that the cooling fluid undergoes a phase change from liquid to gaseous during expansion, and an enthalpy of vaporization released during the phase change cools the rotor.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a first embodiment of an electric machine according to the present invention;

FIG. 2 illustrates a further embodiment of an electric machine according to the present invention; and

FIG. 3 illustrates an axial section of an embodiment of an electric machine according to the present invention.

### DETAILED DESCRIPTION

Embodiments of the present invention provide a method for cooling, and an electric machine having improved cooling, in order to enable effective cooling, in particular embodiments in the case of impending overheating. Embodiments of the present invention at least partially overcome at least one of the disadvantages described above.

The features and details described in connection with the method according to embodiments of the present invention naturally also apply in connection with the electric machine according to embodiments of the present invention and vice versa, so that mutual reference is or can be made to the disclosure of the individual aspects of the embodiments of the present invention.

According to a first aspect, embodiments of the present invention relate to a method for cooling an electric machine by means of a cooling unit, in particular embodiments for an electric vehicle, having a stator arranged in a housing, a rotor and at least one cooling channel arranged on the stator, wherein a compressed cooling fluid is fed through the cooling channel and the cooling fluid is released and decompresses in the direction of the rotor via at least one nozzle formed on the cooling channel, such that the cooling fluid undergoes a phase change from liquid to gaseous during expansion, and the enthalpy of vaporization released during the phase change cools the rotor. The method allows efficient cooling of an electric machine by selectively feeding a compressed cooling fluid into a cooling channel arranged in the stator. The cooling channel is provided with a feeder that feeds the cooling fluid into the system under pressure. The fluid is released in the direction of the rotor via one or more nozzles formed in the cooling channel. These nozzle(s) may be designed as holes in the cooling channel or comparable geometries, for example, as oblique or conical outlet apertures, in order to specifically influence the flow.

As the cooling fluid exits through the nozzles, it undergoes expansion, whereby a pressure drop occurs. This process results in a change of phase state of the fluid from liquid to gaseous. The enthalpy of vaporization released during vaporization causes additional heat absorption by the fluid, which leads to increased thermal flow from the rotor into the cooling medium. This mechanism allows for particularly effective heat dissipation, since the latent heat transfer reduces the thermal stress.

The configuration of the nozzles allows targeted control of the direction of flow of the gaseous coolant. The flow of the medium onto the rotor through the nozzles may occur at different angles so that optimum wetting of the rotor surface is achieved. By means of an oblique or tangential flow, the efficiency of the heat transfer can be further improved as even cooling across the entire rotor surface can be ensured. In preferred embodiments, the coolant outflow direction is such that the rotor surface is directly sprayed to maximize the heat exchange locally.

Since the coolant is explicitly applied to the rotor, the conventional liner of the machine may be omitted. The liner is used in known machines for sealing and thermal separation between stator and rotor. The targeted spray-cooling mechanism eliminates the need for a separate separation structure, thereby reducing cost, manufacturing complexity, and potential thermal barriers.

The stator contains electrical conductors that are responsible for generating the magnetic field of the machine. In a preferred embodiment, these conductors may be configured as hairpin conductors. Hairpin conductors are made of solid rectangular copper rods, which allow for a compact and low-loss winding structure through interconnection. The integration of the cooling channels into the stator allows a thermally optimized arrangement of the heat sources and cooling media, whereby a high power density can be realized.

The at least one cooling channel may be positioned in different areas of the stator. One possible arrangement is the integration of the channel into a groove opening of the stator. Alternatively, the cooling channel may be accommodated in a stator tooth. In both cases, the cooling fluid may be efficiently directed towards the outflow nozzles to ensure targeted and even spraying of the rotor.

In the context of embodiments of the present invention, it may be advantageous that the cooling fluid is only released if an increase in the temperature of the rotor over a specified threshold is detected. The method may thus be supplemented by a control strategy that enables a targeted and needs-based activation of the coolant release. In this case, the cooling fluid is released only if an increase in the temperature of the rotor above a specified threshold is detected. Detection of this temperature is carried out by a temperature monitoring unit, which is in thermal contact with the rotor or indirectly senses the heating through measurements in the stator area and infers the rotor temperature via a mathematical model.

In order to control the release of coolant based on the temperature of the rotor, a control unit is provided that activates or deactivates the fluid supply or regulates the flow rate. This control unit may be associated with temperature sensors or the temperature monitoring unit, which operate either directly on the rotor or indirectly via inference methods. The controller continuously evaluates the sensor data and initiates the coolant release only if the temperature of the rotor exceeds a critical threshold. Once the rotor has cooled sufficiently by the release of the cooling fluid and the temperature falls below the threshold again, the cooling fluid/media release is stopped.

This control strategy helps to minimize undesirable effects that could result from the permanent presence of gaseous cooling fluid in the air gap between the rotor and the stator. Since the gaseous cooling fluid causes additional frictional losses due to its density and viscosity, it is undesirable that the fluid remains permanently in the air gap. Continuous cooling could lead to degradation of the efficiency of the electric machine, as the frictional losses in the air gap may lead to a reduction in efficiency. Through the targeted and short-term activation of the cooling, this disadvantage is avoided while simultaneously achieving an effective reduction of the rotor temperature.

The operational strategy is designed to lower the rotor temperature as quickly as possible by releasing the cooling fluid, for example, at short intervals. Due to the high heat absorbency of the fluid during the phase change, the temperature of the rotor can be lowered within a short time, thereby avoiding overheating. This ensures that the machine always operates within its thermal operating limits without a long-term reduction in efficiency due to excessive friction in the air gap.

In the context of embodiments of the present invention, it is conceivable that the cooling fluid is removed, and in particular embodiments aspirated from the housing of the electric machine after vaporization. This is done in particular embodiments with a targeted integrated suction device that efficiently removes the decompressed gaseous fluid from the interior of the machine. The aspiration ensures that the cooling fluid does not accumulate in the air gap between the rotor and stator or in other areas of the machine interior after expansion, thereby avoiding negative effects on the operation of the machine.

The positioning of the suction device may vary depending on the design of the electric machine. One option is to place the suction device opening in an area of the machine housing where the gaseous fluid is , in preferred embodiments, directed by rotor rotation or by natural flow effects. Another option is to selectively locate the suction device near the coolant nozzles so that the gaseous fluid is removed from the system immediately following heat absorption. In both cases, through optimized positioning of the suction points, effective fluid guidance can be achieved, thereby preventing undesirable accumulation of the cooling medium inside the machine.

The aspiration may be accomplished either by natural pressure compensation or by active conveyance of the fluid. In a passive variant, the gaseous cooling fluid is removed via pressure differentials between the machine interior and the environment so that automatic venting of the system occurs. In an active variant, an external pump may be utilized to selectively aspirate the fluid from the machine housing and direct it to an external cooling or recondensation device.

The cooling fluid may be discharged through the at least one nozzle into an air gap between the stator and the rotor. This arrangement introduces the gaseous cooling medium directly into the area where the rotor is moving, thereby allowing for immediate heat dissipation.

The flow of the gaseous coolant through the nozzles may occur at different angles to ensure the most efficient heat transfer. For example, a suitable nozzle assembly may provide direct radially directed injection into the air gap, thereby achieving a rapid mixing of the fluid with the ambient rotating air. Alternatively, a tangential flow may be provided in which the gaseous cooling medium is introduced with a flow component along the rotational direction of the rotor. This variant may reduce the flow resistance in the air gap while providing for improved distribution of the cooling fluid along the rotor surface.

The targeted feeding of the cooling medium into the air gap results in a separate separation structure between the stator and rotor, for example in the form of a liner, being eliminated. In conventional systems, a liner is employed to seal the air gap against external influences or to ensure thermal separation between the machine components. Since the cooling fluid is, in preferred embodiments, to be sprayed onto the rotor, such a barrier is no longer required. By eliminating the liner, mechanical complexity and manufacturing costs can be reduced while improving the thermal coupling between cooling medium and rotor.

According to a second aspect, embodiments of the present invention further relates to an electric machine for an electric vehicle, comprising a stator, a rotor, a cooling unit, in particular embodiments for carrying out the method, wherein the cooling unit comprises a cooling channel arranged on the stator, wherein a compressed cooling fluid is arranged in the cooling channel, and at least one nozzle is formed on the cooling channel, through which the cooling fluid is conveyed out of the cooling channel in the direction of the rotor and decompresses, such that heat dissipation from the rotor can be achieved by means of the phase change of the cooling fluid from liquid to gaseous.

This results in the same advantages for an electric machine according to embodiments of the present invention as those already described for a method according to embodiments of the present invention.

The electric machine includes a stator, a rotor, and a cooling unit for targeted cooling of the rotor. The cooling unit is, in preferred embodiments, configured to perform the method according to embodiments of the present invention for cooling an electric machine. A cooling channel is arranged on the stator in order to enable direct coolant guidance into the vicinity of the thermally loaded areas of the machine.

The cooling channel is designed to be fed with a compressed cooling fluid. This fluid is held under pressure within the channel and can be discharged in the direction of the rotor via targeted control through one or more nozzles formed on the cooling channel. The nozzles are configured to release the cooling fluid upon flowing out of the cooling channel, thereby causing expansion and thus pressure reduction. Through this process, the cooling fluid undergoes a phase transition from the liquid to the gaseous phase. The enthalpy of vaporization released thereby leads to efficient heat absorption from the environment, whereby targeted cooling of the rotor occurs.

The electric machine is configured so that positioning the cooling channel within the stator allows for precise fluid guidance. The cooling fluid may be selectively fed into the air gap between the rotor and stator, thereby immediately cooling the rotor surface. The nozzles may be designed to allow the fluid to flow out at different angles. A radial arrangement may allow for direct wetting of the rotor surface, while a tangential injection optimizes the flow characteristics in the air gap by leveraging the rotor’s natural rotation to achieve an even distribution of the gaseous fluid.

The targeted feeding of the cooling fluid and the direct cooling of the rotor surface eliminate the need for a liner between stator and rotor. Conventional machines employ a liner for thermal and mechanical separation, which requires additional structure within the machine housing. Since the cooling medium is selectively sprayed onto the rotor, this barrier may be eliminated, simplifying manufacturing and improving the thermal transition between the cooling medium and the rotor.

In embodiments, the cooling channel may be arranged, at least in sections, on a groove opening of the stator or on a stator tooth. The electric machine may be further designed such that the cooling channel is arranged, at least in sections, on a groove opening of the stator or on a stator tooth. This arrangement allows targeted guidance of the cooling fluid in close proximity to the thermally loaded areas of the machine, in particular embodiments the electrical conductors in the stator and the air gap between the stator and rotor. This positioning can achieve particularly efficient heat transfer because the cooling medium is fed directly to the locations where the greatest heat generation occurs.

The integration of the cooling channel into the groove opening of the stator allows the cooling fluid to be guided immediately along the windings. In a preferred embodiment, the electrical conductors are configured as hairpin conductors having a compact winding structure with high electrical conductivity. These conductors are arranged within the grooves of the stator and contribute to the electromagnetic field formation of the machine. Since significant heat generation occurs due to the ohmic losses of the conductors, targeted cooling in this area can help to reduce the thermal load on the windings and ensure even temperature distribution.

Alternatively or additionally, the cooling channel may also be positioned on a stator tooth. The stator tooth is the area between two adjacent grooves and serves as a mechanical and magnetic connection within the stator. The arrangement of the cooling channel on a stator tooth provides the advantage that the cooling fluid can be guided directly into the air gap between the stator and the rotor. This allows the rotor to be sprayed with the cooling fluid in a targeted manner so that the vaporization can occur directly at the rotor surface. By changing phases of the fluid, the released enthalpy of vaporization is utilized to allow for effective heat dissipation.

Placement of the cooling channel in these areas allows for targeted control of the fluid flow within the machine. The cooling fluid may be directed to exit the cooling channel via nozzles at defined angles. This arrangement allows for a need-based distribution of the fluid inside the machine, thereby achieving targeted heat dissipation in critical locations. In an advantageous embodiment, tangential injection of the fluid into the air gap can occur to promote even distribution along the rotor surface and minimize undesirable flow losses.

This arrangement of the cooling channel allows the cooling fluid to be efficiently integrated into the cooling system of the electric machine. The ability to discharge the fluid directly at the thermally relevant areas contributes to improved cooling performance and enables a compact design of the machine. The targeted cooling of the stator windings and the rotor results in thermal stabilization of the overall system, whereby higher power densities can be achieved. At the same time, the defined positioning of the cooling channels ensures that the fluid is not distributed in an uncontrolled manner inside the machine, but instead acts in a targeted manner where the thermal load is the highest.

In embodiments, an outlet for the vaporized cooling fluid is provided on a housing of the electric machine, in particular embodiments with a suction device such that the decompressed gaseous cooling fluid can be removed, in particular aspirated, from the electric machine. This outlet serves to selectively remove the decompressed gaseous cooling fluid from the inside of the machine to avoid uncontrolled accumulation of the fluid in the housing. Efficient removal of the vaporized cooling medium helps to reduce flow losses in the air gap between the rotor and stator and to ensure a constant thermal operating environment of the machine.

The placement of the outlet may be designed so that the gaseous cooling fluid may escape from the interior of the machine in the shortest manner. Depending on the design of the electric machine, the outlet may be provided at a position in the housing that is favored by the natural flow direction of the cooling fluid. The rotation of the rotor and the aerodynamic effects within the machine create a flow distribution that can be used to selectively direct the vaporized fluid towards the intended outlet. This may be supported by a suitable housing geometry or by guiding elements within the machine room.

In a further developed embodiment, the outlet may be combined with a suction device such that the decompressed gaseous cooling fluid may be actively removed from the electric machine. Such suction may be realized, for example, by a pump or by a fluidically optimized pressure difference between the machine interior and the environment. In particular embodiments, in the case of closed cooling circuits, the suction device may be designed so that the aspirated cooling fluid is supplied to an external condensation system in which it is liquefied and returned to the cooling circuit again.

The targeted removal of the vaporized cooling fluid ensures that the medium does not remain in the air gap between the rotor and the stator and cause additional friction losses therein. Uncontrolled accumulation of the fluid could result in the rotor being subjected to higher flow resistance due to the increased density of the medium, which could adversely affect the efficiency of the machine. Targeted suction avoids this effect so that the electric machine can be operated at maximum efficiency.

In addition, the provided fluid removal helps to keep the thermal environment of the machine stable. Since the vaporized cooling medium absorbs and dissipates heat from the rotor, efficient derivation from the machine housing can help ensure continuous temperature control. In a closed system variant, the aspirated fluid may be fed back into the cooling channels after recondensation to allow for resource-conserving use of the coolant. Alternatively, in open systems, the vaporized fluid may be discharged into the environment via the outlet, provided this is compatible with the particular operating conditions of the machine.

In the context of embodiments of the present invention, optionally, temperature monitoring for the rotor and a control unit for cooling fluid control can be provided, such that the cooling fluid is only released if a temperature increase of the rotor above a specified threshold is detected. The electric machine may be further designed to provide temperature monitoring for the rotor and a control unit for cooling fluid control. This extension allows targeted and needs-based activation of the cooling, so that the cooling fluid is released only when a temperature increase of the rotor above a specified threshold is detected. This adaptive control increases the efficiency of the machine by using the cooling medium only when it is necessary to regulate the temperature of the rotor.

Temperature monitoring may be realized by different sensors or indirect measurement methods. One option is to directly measure the temperature on the rotor by means of integrated sensors coupled to the controller using wireless data transmission or a slip ring connection. Alternatively, the temperature of the rotor may also be determined indirectly via the temperature sensed in the stator by using thermal models or algorithms to calculate rotor heating. Such model-based calculation may be based on the machine’s electrical operating parameters, such as current, load profile, and speed, to allow for precise estimation of the current rotor heating.

The cooling fluid control unit is coupled to the temperature monitoring unit and processes the sensed sensor data. Once the temperature of the rotor exceeds a previously defined threshold, the control unit outputs a coolant release activation signal. The compressed cooling fluid is then passed through the cooling channel and is decompressed via the nozzles arranged in the cooling channel so that it is released as vaporizing fluid in the direction of the rotor. By changing phases of the cooling medium, the enthalpy of vaporization is used to ensure effective heat dissipation from the rotor. Once the temperature of the rotor falls below the defined threshold again through cooling, the control unit disables supply of the cooling fluid, thereby avoiding unnecessary consumption of the cooling medium.

This targeted control of coolant release helps to minimize undesirable flow impacts in the air gap between the rotor and stator. Since the gaseous cooling fluid can generate additional frictional losses due to its density and viscosity, it is undesirable that the medium remains permanently in the air gap. Cooling is therefore only briefly activated to rapidly lower the rotor temperature without compromising the aerodynamic properties of the machine over extended periods of time. At the same time, energy consumption is optimized by activating the cooling process according to needs, because the cooling system is only active in thermally critical operating conditions.

Furthermore, it may be provided in the context of embodiments of the present invention that a plurality of nozzles is provided, wherein the nozzles are arranged spaced apart from one another along the cooling channel, in particular embodiments such that the nozzles have different flow angles, in particular such that the nozzles are arranged such that tangential flow onto the rotor can be achieved. This arrangement allows for even and targeted distribution of the cooling fluid along the rotor, thereby achieving optimized heat transfer. The plurality of nozzles can ensure that the cooling fluid exits in different areas of the rotor and thus achieve a homogeneous cooling effect across the entire rotor surface. The spacings between the nozzles may be chosen to provide even fluid distribution and no uncooled areas remain on the rotor surface.

The nozzles may differ in their flow angles from one another so that different flow directions of the cooling fluid may be realized. By means of this variation of the injection angles, a targeted control of the flow conditions in the air gap between stator and rotor can be achieved. In a preferred embodiments, an arrangement provides that at least a portion of the nozzles are oriented to allow tangential flow of the cooling fluid onto the rotor. This tangential injection results in the gaseous fluid spreading along the rotor surface, thereby improving the cooling effect and optimizing the aerodynamic properties of the machine.

The combination of different flow angles and tangential injection helps to improve the interaction between the rotating rotor and the cooling fluid. While radial injection of the fluid onto the rotor surface allows for direct heat absorption by vaporization, tangential flow may help to efficiently direct the cooling fluid along the rotor surface. This extends the retention period of the cooling medium in thermal contact with the rotor, thereby optimizing the heat transfer.

The stepped arrangement of the nozzles along the cooling channel may ensure that cooling is not locally limited, but is carried out evenly over the entire length of the rotor. This is particularly advantageous for machines with a high power density, since a homogeneous temperature distribution within the rotor may be required to avoid thermal stresses and undesirable temperature gradients. The targeted variation of the flow angles also allows for an adjustable flow direction within the air gap, which allows the cooling fluid to be efficiently held in the thermally relevant areas.

With respect to embodiments of the present invention, the electric machine may be configured as an asynchronous machine or a synchronous machine. Both machine types have different electromagnetic operating principles, wherein the described cooling concept is implementable regardless of the respective design.

In one embodiment as an asynchronous machine, the rotor is typically embodied as a short-circuit ring or slip ring rotor The short-circuit ring rotor includes a cage of electrically conductive bars connected by end rings. In this design, induction currents occur in the rotor through the rotating field generated by the stator windings, which generate the torque. The heat generation in the rotor results, in particular embodiments, from the ohmic losses caused by the electrical resistance of the conductors as well as from additional eddy current losses in the metallic components of the rotor. The integration of the described cooling method into an asynchronous machine allows a targeted discharge of these losses, especially at high speeds and high load conditions, in which excessive heating of the rotor may occur.

In one embodiment as a synchronous machine, the machine may operate with permanent magnets or external excitation. In a permanent magnet synchronous machine (PMSM), magnetic materials, for example neodymium iron boron magnets, are arranged on or within the rotor. The temperature of the permanent magnets has a direct impact on the magnetic properties, as the retentivity of the magnets decreases with increasing temperature. Overheating of the rotor may therefore lead to power loss and irreversible demagnetization. Targeted spray cooling of the rotor with vaporizing cooling fluid can efficiently lower the temperature of the magnets, thereby improving the performance and life of the machine.

In an externally excited synchronous machine, the magnetic field of the rotor is generated by an excitation winding that is supplied with current by means of slip rings. The resulting losses in the rotor result from the heating of the excitation winding and from eddy current losses in the rotating components. Again, the cooling method allows for direct temperature regulation of the rotor to reduce thermal stresses and improve the efficiency of the machine.

Further advantages, features, and details of the invention are apparent from the following description, in which several example embodiments of the invention are described in detail with reference to the drawings. The features mentioned in the claims and in the description can be essential to the invention individually or in any combination. The figures show schematically:

In the figures, identical reference symbols are used for the same technical features, even in different example embodiments.

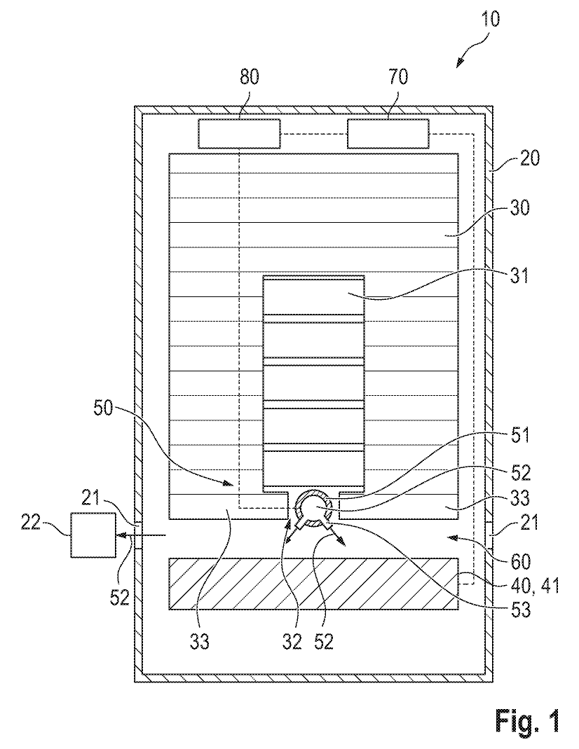

FIG. 1 schematically illustrates an embodiment of an electric machine that implements the cooling method according to embodiments of the present invention. The electric machine 10 is surrounded by a housing 20 that forms a closed structure, and in which the stator 30 and the rotor 40 are located. The stator 30 includes electrical conductors 31 that are used to generate the electromagnetic field. The conductors 31 are arranged in groove openings 32 of the stator, whereby the groove openings 32 are separated by stator teeth 33. The rotor 40 is rotatably mounted within the housing 20 and has a rotor surface 41 that interacts with the magnetic field of the stator 30. An air gap 60 is formed between the stator 30 and the rotor 40 to ensure the clearance between the rotating and stationary components for the operation of the machine.

The cooling unit 50 is designed to allow targeted cooling of the rotor 40. The cooling channel 51 is arranged within the groove opening 32 of the stator 30 and serves to supply the cooling fluid 52. The cooling fluid 52 is kept under pressure in the cooling channel 51 and is released in the direction of the rotor 40 via two nozzles 53. The nozzles 53 are arranged at an angle of approximately 90° offset from one another, thereby dispensing the cooling fluid 52 in different directions. This arrangement allows for a targeted distribution of the cooling fluid 52 to ensure even coverage of the rotor surface 41. Upon exiting the nozzles 53, the cooling fluid 52 undergoes expansion, thereby undergoing a phase change from liquid to gaseous. The enthalpy of vaporization released thereby provides immediate heat dissipation from the rotor 40, thereby reducing its temperature.

In order to avoid undesirable accumulation of the vaporized cooling fluid 52 in the housing 20, two oppositely arranged outlets 21 are provided. Each outlet 21 is connected to a suction device 22 that removes the gaseous cooling medium from the inside of the machine. The positioning of outlets 21 is selected so that the vaporized fluid can be efficiently removed from the air gap 60, thereby minimizing aerodynamic losses and optimizing flow ratios within the machine.

For needs-based control of the cooling process, the electric machine 10 includes temperature monitoring 70 that senses the thermal load of the rotor 40. The sensed temperature values are communicated to a controller 80 that regulates the cooling process as a function of the measured temperature. The controller 80 only activates the feeding of the cooling fluid 52 if the temperature of the rotor 40 exceeds a specified threshold. Once the temperature falls below this threshold again through the cooling process, the supply of cooling fluid 52 is stopped so that the cooling process is efficient and conserves resources.

By means of this targeted control, it can be ensured that the cooling fluid 52 is only used during thermally critical operating conditions, thereby optimizing the efficiency of the machine. At the same time, the cooling medium is prevented from permanently remaining in the air gap 60 and causing additional frictional losses therein.

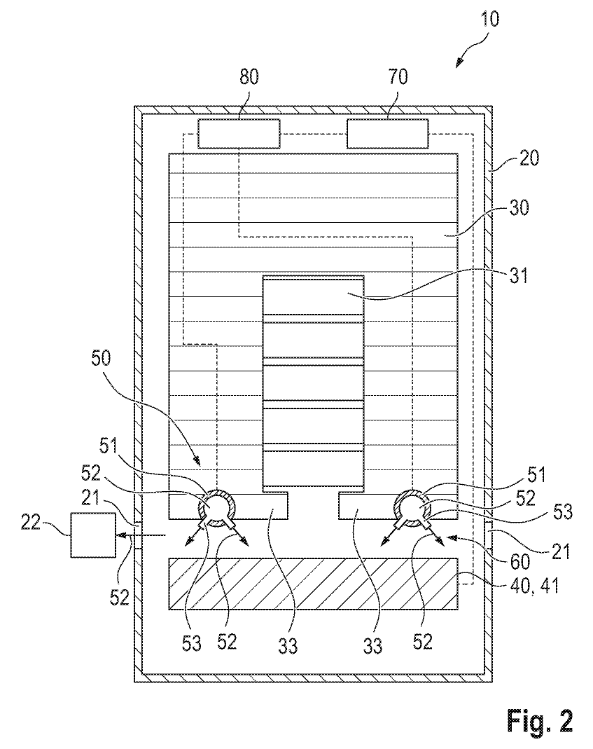

FIG. 2 schematically illustrates another embodiment of an electric machine that implements the cooling method according to embodiments of the present invention. The electric machine 10 is surrounded by a housing 20 that forms a closed structure, and in which the stator 30 and the rotor 40 are located. The stator 30 includes electrical conductors 31 that are used to generate the electromagnetic field. The conductors 31 are arranged in groove openings 32 of the stator. The rotor 40 is rotatably mounted within the housing 20 and has a rotor surface 41 that interacts with the magnetic field of the stator 30. An air gap 60 is formed between the stator 30 and the rotor 40 to ensure the clearance between the rotating and stationary components for the operation of the machine.

In contrast to the embodiment shown in FIG. 1, the cooling unit 50 is designed here such that the cooling channel 51 is not arranged in a groove opening 32 of the stator, rather in or on the stator teeth 33. This positioning of the cooling channel 51 allows direct guidance of the cooling fluid 52 along the stator teeth 33. By means of this alternative arrangement, the cooling fluid 52 may be efficiently guided in the direction of the air gap 60 and thus in the immediate vicinity of the rotor 40. This results in improved heat transfer as the cooling fluid 52 is selectively introduced into the area where the rotor 40 moves and where the highest temperatures occur.

The cooling fluid 52 is kept under pressure in the cooling channel 51 and is released in the direction of the rotor 40 via one or more nozzles 53. The nozzles 53 are positioned along the stator teeth 33 and may be oriented such that tangential or radial flow of the cooling fluid 52 onto the rotor surface 41 occurs. Upon exiting the nozzles 53, the cooling fluid 52 undergoes expansion, thereby undergoing a phase change from liquid to gaseous. The enthalpy of vaporization released thereby provides immediate heat dissipation from the rotor 40, thereby reducing its temperature.

In order to avoid undesirable accumulation of the vaporized cooling fluid 52 in the housing 20, two oppositely arranged outlets 21 are provided. Each outlet 21 is connected to a suction device 22 that removes the gaseous cooling medium from the inside of the machine. The positioning of outlets 21 is selected so that the vaporized fluid can be efficiently removed from the air gap 60, thereby minimizing aerodynamic losses and optimizing flow ratios within the machine.

For needs-based control of the cooling process, the electric machine 10 includes temperature monitoring 70 that senses the thermal load of the rotor 40. The sensed temperature values are communicated to a controller 80 that regulates the cooling process as a function of the measured temperature. The controller 80 only activates the feeding of the cooling fluid 52 if the temperature of the rotor 40 exceeds a specified threshold. Once the temperature falls below this threshold again through the cooling process, the supply of cooling fluid 52 is stopped so that the cooling process is efficient and conserves resources.

This alternative arrangement of the cooling channel 51 in or on the stator teeth 33 achieves optimized fluid guidance within the machine. The positioning along the stator teeth 33 allows for optimized feeding of the cooling fluid 52 into the air gap 60, thereby achieving even cooling of the rotor 40. At the same time, the compact design of the machine is retained as the cooling channel 51 may be directly integrated into the structure of the stator 30. The targeted suction device 22 ensures that the vaporized cooling fluid 52 is removed from the machine in a controlled manner, thereby ensuring a thermally stable mode of operation.

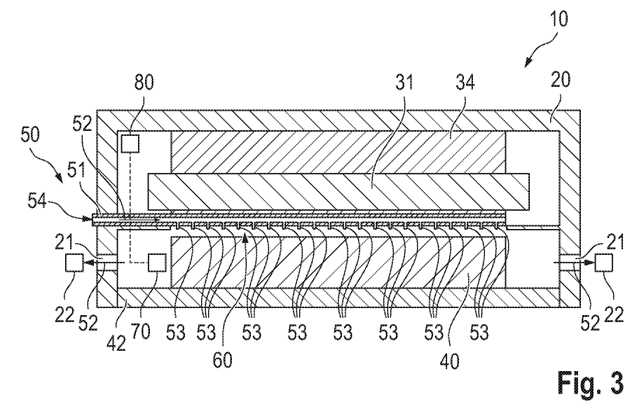

FIG. 3 shows an axial section of the electric machine 10 with a cooling channel 51 in the groove opening 32. The essential features correspond to those of the embodiments described above. The electric machine 10 includes a housing 20 that encloses the machine components and provides mechanical protection. The stator yoke 34 forms the rear region of the stator 30. The rotor 40 is located in the housing 20, which rotor interacts with the air gap 60 via a rotor surface. The rotor 40 is mounted on a rotor shaft 42 that transmits the rotational torque and provides a mechanical connection to the drive elements of the machine.

The cooling channel 51 is integrated in the groove opening 32 of the stator 30 and serves to selectively feed the cooling fluid 52. In contrast to the previous figures, a plurality of nozzles 53 can be seen adjacent to one another within the cooling channel 51 in this FIG. 3. These nozzles 53 allow for even distribution of the cooling fluid 52 along the axial direction of the machine. The cooling fluid 52 is fed into the cooling channel 51 via an inlet 54, through which the cooling fluid 52 is supplied under pressure. The arrangement of the inlet 54 is, in preferred embodiments, designed for the cooling fluid 52 to pass into the cooling channel 51 with minimal flow losses, thereby ensuring even distribution within the cooling channel 51.

The cooling fluid 52 is fed under pressure into the cooling channel 51 and is decompressed upon exiting the nozzles 53. The arrangement of multiple nozzles 53 ensures that the fluid is released at multiple positions along the groove opening 32, thereby achieving optimized cooling of the air gap 60 and rotor surface 41. Upon exiting the nozzles 53, the cooling fluid 52 undergoes expansion, thereby undergoing a phase change from liquid to gaseous. The enthalpy of vaporization released thereby causes immediate heat dissipation from the rotor 40, thereby reducing its temperature in a controlled manner. The positioning of nozzles 53 along the axial direction of the cooling channel 51 ensures that the cooling fluid 52 is distributed over the entire length of the machine so that no locally overheated areas occur in the rotor 40.

The removal of the vaporized cooling fluid 52 occurs via the outlets 21 provided on opposite sides of the housing 20. Each outlet 21 is connected to a suction device 22 that selectively removes the gaseous fluid from the machine. This suction device 22 ensures that the cooling fluid 52 does not remain in the air gap 60 after vaporization and cause additional flow losses or undesirable resistance therein.

For needs-based control of the cooling process, temperature monitoring 70 is provided that monitors the thermal load of the rotor 40. The sensed temperature values are passed on to a controller 80 that regulates the cooling process as a function of the measured temperature. Once the temperature of the rotor 40 exceeds a specified threshold, the controller 80 activates the feeding of cooling fluid 52 into the cooling channel 51. Targeted control ensures that the cooling fluid 52 is released only when a critical temperature is reached, thereby ensuring efficient use of the cooling medium.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for cooling an electric machine comprising a cooling unit, a stator arranged in a housing, a rotor, and at least one cooling channel arranged on the stator, the method comprising:
feeding a compressed cooling fluid through the at least one cooling channel; and
releasing and decompressing the cooling fluid in a direction of the rotor via at least one nozzle formed on the at least one cooling channel, such that the cooling fluid undergoes a phase change from liquid to gaseous during expansion, and an enthalpy of vaporization released during the phase change cools the rotor.

2. The method according to claim 1, wherein the cooling fluid is released only when an increase in a temperature of the rotor above a specified threshold is detected.

3. The method according to claim 1, wherein the cooling fluid is aspirated from the housing of the electric machine after vaporization.

4. The method according to claim 1, wherein the cooling fluid is discharged through the at least one nozzle into an air gap between the stator and the rotor.

5. The electric machine for an electric vehicle, comprising the stator, the rotor, and the cooling unit adapted for carrying out the method according to claim 1, wherein the cooling unit comprises the at least one cooling channel arranged on the stator, wherein the compressed cooling fluid is arranged in the at least one cooling channel, and the at least one nozzle is formed on the at least one cooling channel, through which the cooling fluid is conveyed out of the at least one cooling channel in the direction of the rotor and decompresses, such that heat dissipation from the rotor is based on the phase change of the cooling fluid from liquid to gaseous.

6. The electric machine according to claim 5, wherein the at least one cooling channel is arranged, at least in sections, on a groove opening of the stator or on a stator tooth.

7. The electric machine according to claim 5, wherein an outlet for the vaporized cooling fluid is provided on the housing of the electric machine with a suction device such that the decompressed gaseous cooling fluid can be aspirated from the electric machine.

8. The electric machine according to claim 5, wherein temperature monitoring is provided for the rotor and a control unit is provided for cooling fluid control, such that the cooling fluid is only released if an increase in a temperature of the rotor above a specified threshold is detected.

9. The electric machine according to claim 5, wherein a plurality of nozzles is provided, wherein the plurality of nozzles are arranged spaced apart from one another along the at least one cooling channel such that the plurality of nozzles have different flow angles.

10. The electric machine according to claim 5, wherein the electric machine is configured as an asynchronous machine or a synchronous machine.

11. The method according to claim 1, wherein the electric machine is for an electric vehicle.

12. The electric machine according to claim 9, wherein the plurality of nozzles are further arranged such that the plurality of nozzles cause tangential flow onto the rotor.

13. An electric machine for an electric vehicle, the electric machine comprising:
a stator; a rotor; and a
cooling unit,
wherein the cooling unit comprises a at least one cooling channel arranged on the stator, the at least one cooling channel being configured to receive a compressed cooling fluid;
wherein at least one nozzle is arranged on the at least one cooling channel, which is configured to convey the cooling fluid out of the at least one cooling channel in a direction of the rotor and such that the cooling fluid decompresses, such that heat dissipation from the rotor is based on a phase change of the cooling fluid from liquid to gaseous.

14. The electric machine according to claim 13, wherein the at least one cooling channel is arranged, at least in sections, on a groove opening of the stator or on a stator tooth.

15. The electric machine according to claim 13, wherein an outlet for the vaporized cooling fluid is provided on the housing of the electric machine with a suction device such that the decompressed gaseous cooling fluid can be aspirated from the electric machine.
